(19) United States
(12) Patent Application Publication
(10) Pub. No.: US 2007/0132969 A1
(43) Pub. Date: Jun. 14, 2007

(54) Microlithographic projection exposure apparatus and method for introducing an immersion liquid into an immersion space

(75) Inventors: Bernhard Gellrich, Aalen (DE); Gerd Reisinger, Oberkochen (DE); Dieter Schmerek, Huettlingen (DE); Jens Kugler, Heubach (DE)

Correspondence Address: FACTOR & LAKE, LTD, 1327 W. WASHINGTON BLVD., SUITE 5G/H, CHICAGO, IL, 60607, US

(73) Assignee: CARL ZEISS SMT AG, Oberkochen (DE)

(21) Appl. No.: 10/565,612

(22) PCT Filed: Jul. 8, 2004
(86) PCT No.: PCT/EP04/07456

§ 371 Date: Jul. 6, 2006

(30) Foreign Application Priority Data
Jul. 24, 2003 (DE) 103 33 644.3

(51) Int. Cl. G03B 27/42

(52) U.S. Cl. 355/53; 355/30

(57) ABSTRACT

The invention relates to a projection exposure system for microlithography, said system comprising an illumination device for generating a projection light, and a projection objective comprising a plurality of optical elements such as lenses (L5) and enabling a reticle that can be arranged in an object plane of the projection objective to be imaged onto a light-sensitive surface (26) that can be arranged in an image plane of the projection objective and is applied to a carrier (30). The inventive system is also provided with an immersion device between an image-side last optical element (L5) of the projection objective and the light-sensitive surface (26), for introducing an immersion liquid (34) into an immersion chamber (50). Said immersion device comprises means (44; 66) which can prevent the appearance of gas bubbles (48) in the immersion liquid (34), affecting the imaging quality, and/or can remove existing gas bubbles (48). Said means can be, for example, an ultrasound source (66) or a degasifier (44).

The invention relates to a projection exposure apparatus for microlithography, having an illumination device for generating projection light, a projection objective with a plurality of optical elements, by which a reticle that can be arranged in an object plane of the projection objective can be imaged onto a photosensitive surface, which can be arranged in an image plane of the projection objective and is applied on a support, and having an immersion device for introducing an immersion liquid into an immersion space between a last optical element on the image side of the projection objective and the photosensitive surface. The invention also relates to a method for introducing an immersion liquid into such an immersion space.

A projection exposure apparatus and a method of this type are known from EP 0 023 243 A1. In order to hold a semiconductor wafer to be exposed, this known projection exposure apparatus has an open-topped container whose upper edge is higher than the lower delimiting surface of the last lens on the image side of the projection objective. Feed and discharge lines for an immersion liquid open into the container, and these are connected to a pump, a temperature regulating device and a filter for cleaning the immersion liquid. When the projection exposure apparatus is in operation, the immersion liquid is circulated in a liquid circuit while an intermediate space, which is left between the lower delimiting surface of the last lens on the image side of the projection objective and the semiconductor wafer to be exposed, remains filled. The resolving power of the projection objective is intended to be increased because of the higher refractive index of the immersion liquid, which in this known projection exposure apparatus preferably corresponds to the refractive index of the photosensitive layer applied on the semiconductor wafer.

A projection exposure apparatus having an immersion device is furthermore known from WO 99/49504. In this projection exposure apparatus, the feed and discharge lines for the immersion liquid open directly at the lower delimiting surface of the last lens on the image side of the projection objective. Using a plurality of such feed and discharge lines, which may for example be arranged in a ring around the last lens on the image side, makes it possible in particular to obviate a surrounding container since immersion liquid flowing away laterally is sucked out and delivered so that the immersion space between the last lens on the image side and the photosensitive surface remains filled with immersion liquid.

Generally speaking, immersion lithography promises very large numerical apertures and a greater depth of focus. However, the imaging quality of microlithographic immersion objectives leaves something to be desired in many cases.

It is therefore an object of the invention to provide a projection objective of the type mentioned in the introduction, with which it is possible to achieve a higher imaging quality.

This object is achieved in that the immersion device comprises means by which the creation of gas bubbles in the immersion liquid can be prevented and/or gas bubbles which have already been created can be removed.

The invention is based on the discovery that bubbles in the immersion liquid are one of the causes of imaging errors. This is because the immersion liquids used, for example water or particular oils, contain inherently dissolved gases which enter the gas phase in the event of pressure and/or temperature changes and thereby lead to the creation of bubbles.

Such pressure changes occur, for example, when the immersion space between the last optical element on the image side and the photosensitive surface is filled with the immersion liquid before the start of projection. It is furthermore always necessary to fill the immersion space with immersion liquid when a support having an already exposed photosensitive layer is replaced by a support whose photosensitive layer is still unexposed.

Movements of the support relative to the projection objective, such as those which occur both in pure steppers or scanners and in projection exposure apparatus for which step-wise and continuous movements of the support are combined, are another cause of pressure variations which lead to the creation of bubbles. Particularly at the edges of the photosensitive surface, undesired pressure variations can occur during these movements. Pressure variations that lead to bubble formation can furthermore occur in the intermediate regions of particular surface structures.

A similar problem is also encountered with measurement heads for projection objectives, which are introduced into the image plane instead of the support in order to determine the imaging quality of the projection objective. The sensor head is moved through under the projection objective within the image plane during the measurements, so that bubble formation may likewise take place.

The immersion device according to the invention may, for example, comprise a suction device for extracting gas bubbles, which has a suction gland opening into the immersion space. This suction gland, which can be provided in addition to a suction gland that may furthermore be required in order to circulate the immersion liquid, preferably extracts immersion liquid, with bubbles contained in it, in the immediate vicinity of the last optical element on the image side, so that these bubbles cannot impair the imaging quality.

If the support can be displaced in a scanning direction of the projection exposure apparatus, then it is expedient for the immersion device to have a side wall which at least partially bounds the immersion space and is designed so as to substantially prevent at least lateral run-off of the immersion liquid transversely to the scanning direction. This reduces inhomogeneities of the immersion liquid perpendicularly to the scanning direction. Inhomogeneities parallel to the scanning direction, on the other hand, are less critical when scanning because averaging is carried out in this direction by the scanning.

It is nevertheless particularly preferable for the side wall to completely, preferably annularly, enclose the last optical element on the image side. This prevents any undesired run-off of immersion liquid.

Another way of removing bubbles which have been created in the immersion liquid is for an ultrasound source, by which the side wall can be set in oscillation, to be coupled to the side wall. Since the bubbles per se do in fact break up by themselves but the time taken for this is relatively long, by applying an ultrasound field acting on the side wall it is possible to excite the immersion liquid in oscillations so that break-up of the bubbles can be significantly accelerated. This is because the bubbles are set into high-frequency oscillations and thus deformed by the ultrasound field, so that the break-up process is accelerated.

It is furthermore preferable for the immersion device to have circulation means for circulating the immersion liquid in the immersion space, which comprise a circulating pump, a filling gland opening into the immersion space and a suction gland opening into the immersion space. By means of this, in circulating operation, it is possible for the immersion liquid to be constantly cleaned, thermally regulated and also degassed, if a degasser for removing gas bubbles from the immersion liquid is additionally provided.

A degasser suitable for this may, for example, have a preferably frustoconical run-off surface arranged in an inclined fashion, onto which immersion liquid can be applied from above and over which a negative pressure can be set up. The effect of this negative pressure is that gases, which are dissolved in the liquid film distributed over the run-off surface, enter the gas phase and emerge from the film.

If the support can be displaced in a scanning direction of the projection exposure apparatus, then it is furthermore preferable for the support to be arranged with respect to the projection objective so as to reduce the extent of the immersion space perpendicularly to the image plane along the scanning direction. Since generally both the photosensitive surface and the image-side delimiting surface of the last optical element on the image side are plane, this arrangement leads to an essentially wedge-shaped immersion space which converges acutely towards the scanning direction. This wedge-shaped immersion space leads to a suction effect during the scanning movement of the support, so that circulation of the immersion liquid in the immersion space requires only a low pump power. Another advantage of the wedge-shaped geometry of the immersion space is that a more uniform fluid flow is created overall in the immersion space.

In this context, it is naturally preferable for the suction gland of the circulation means to be arranged before the filling gland of the circulation means in the scanning direction, since in this way extraction of the immersion liquid is assisted by the scanning movement.

In a preferred configuration of the invention, the circulation means are integrated into the projection objective, preferably in a frame of the last optical element on the image side. It is even feasible to integrate the circulation means into the optical element itself. These measures contribute to keeping the immersion space as smooth and edge-free as possible, and thereby to avoiding turbulence of the immersion liquid which could lead to the creation of bubbles.

Another way in which the occurrence of bubble formation can itself be prevented is for the photosensitive surface to be held in a closed cassette completely filled with immersion liquid, in the object-side wall of which the last optical element on the image side of the projection objective is held so that it can be displaced in a direction parallel to the image plane. In this way, the immersion liquid can be hermetically isolated from the surroundings, so that the other parts of the projection exposure apparatus cannot be contaminated by the immersion liquid. Such a cassette can furthermore be used in a vacuum.

Since it is possible both to introduce the support into the cassette and fill the latter with the immersion liquid outside the beam path of the projection exposure apparatus, these measures can be carried out without time constraint, so that the ingress of gas bubbles can be reliably prevented with the aid of suitable measures. It is furthermore possible to clean the cassette and remove used immersion liquid outside the beam path, and therefore without time constraint.

In order to prevent the creation of gas bubbles owing to the displacement of the last optical element on the image side, the cassette may be in communication with a reservoir using which immersion liquid can optionally be topped up or to which excess immersion liquid can be discharged.

It is, however, preferable for the object-side wall of the cassette to be designed so that the volume filled with the immersion liquid in the cassette does not change when the last optical element on the image side is displaced. In this way, at no time during operation does the immersion liquid come in contact with the surroundings and, in particular, in contact with gases as would be the case with an additional reservoir.

Such a wall may, for example, be produced using a bellows or an arrangement of plate-shaped sub-elements, which can be slid over or into one another in the displacement direction of the last optical element on the image side.

It is furthermore particularly preferable that a flushing liquid different from the immersion liquid can be introduced into the immersion space by the immersion device. Residues of used and contaminated immersion liquid can be removed from the immersion space with the aid of the flushing liquid.

In order to assist cleaning, the support with the photosensitive surface may be replaceable by a cleaning plate, which can be set in motion within a plane parallel to the image plane.

Even the way in which the immersion liquid is introduced into the immersion space for the first time has an influence on the creation of bubbles. The invention therefore also relates to a method for introducing an immersion liquid into an immersion space which is formed between a last optical element on the image side of a projection objective of a projection exposure apparatus for microlithography and a photosensitive surface to be exposed, which is applied on a support.

In order to minimise the formation of bubbles during this process, the following steps are provided:
a) wetting the photosensitive surface and the last optical element on the image side with immersion liquid, the support being outside the beam path of the projection exposure apparatus;
b) bringing the support up to the last optical element on the image side in a movement parallel to the image plane, so that the immersion liquids lying on the last optical element on the image side and on the photosensitive surface touch;
c) introducing the support completely into the optical path in a movement parallel to the image plane, until the support reaches the required position for exposure.

Other advantages and features of the invention will be found in the following description with reference to the drawings, in which:

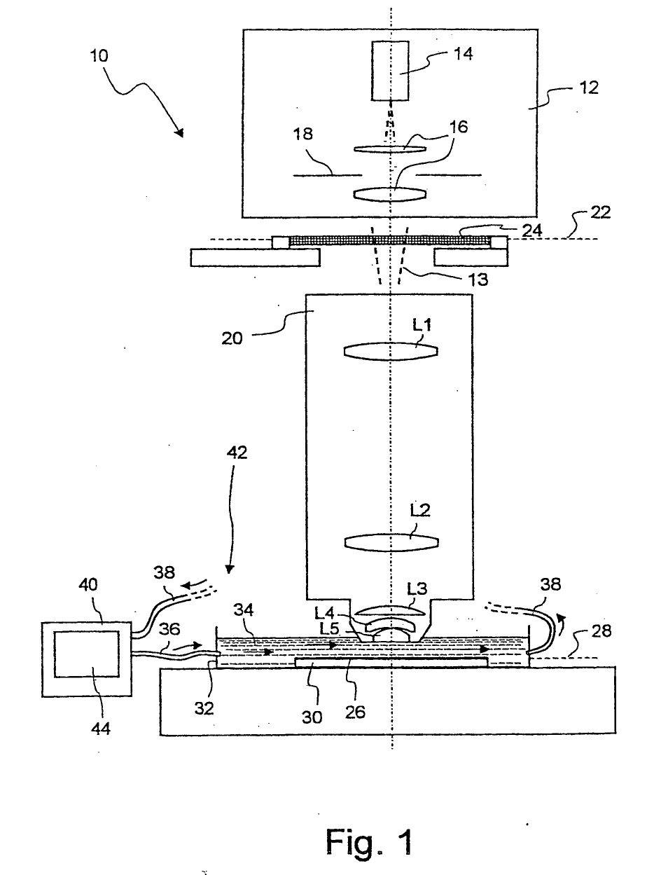

FIG. 1 shows a meridian section through a projection exposure apparatus according to the invention in a highly simplified schematic representation which is not true to scale;

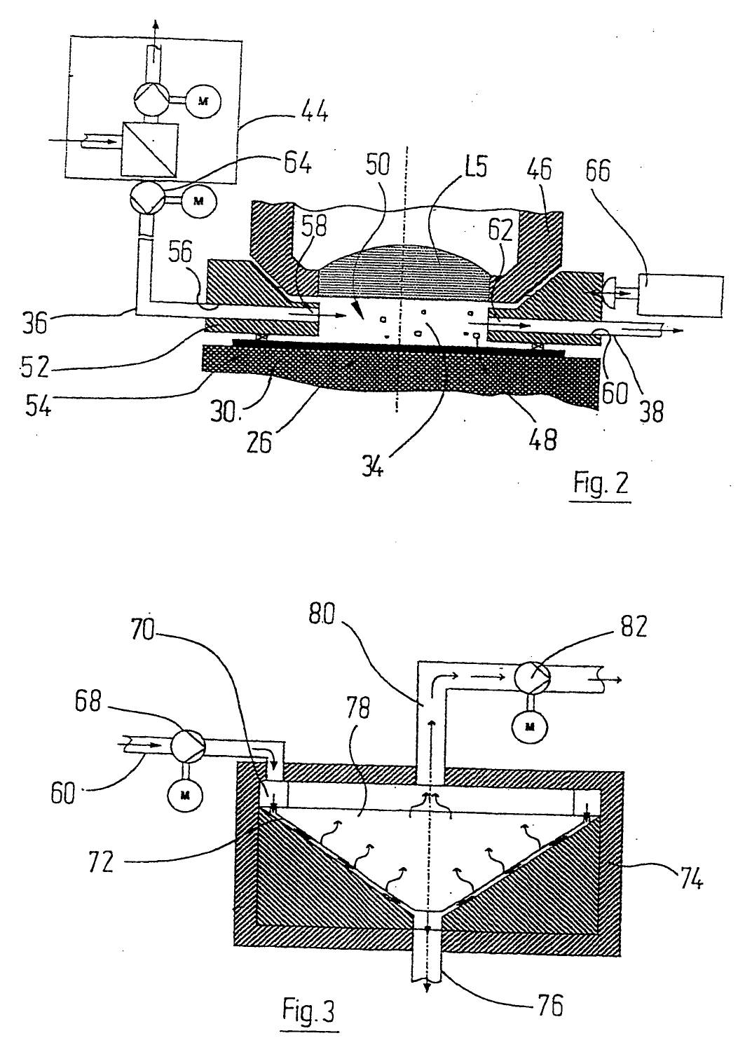

FIG. 2 shows an immersion device according to another exemplary embodiment with a degasser;

FIG. 3 shows the degasser indicated in FIG. 2 in a sectional representation;

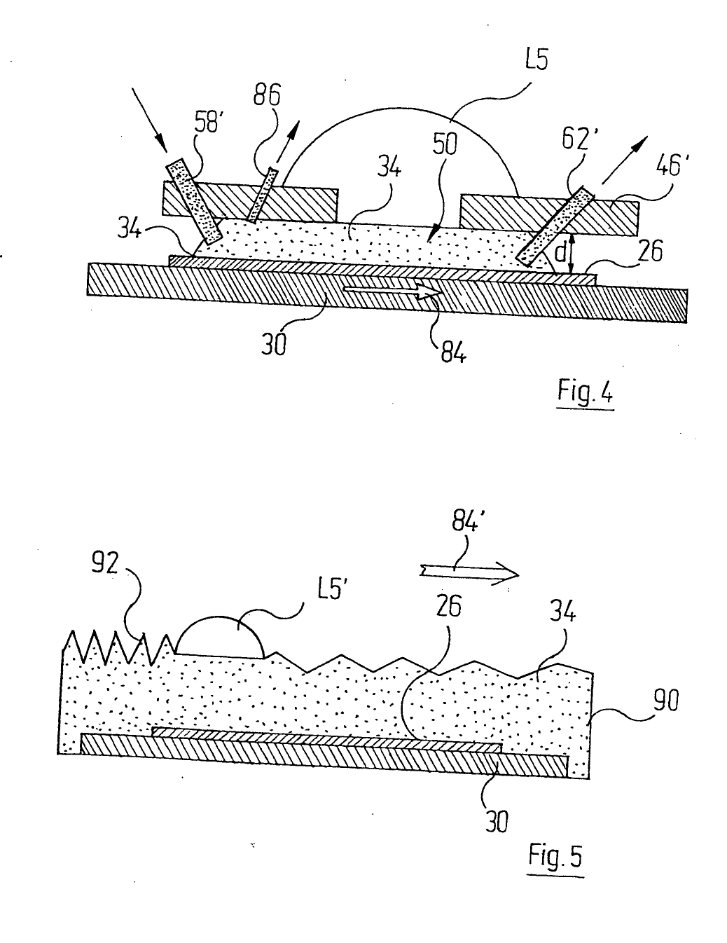

FIG. 4 shows a detail of an immersion device according to a further exemplary embodiment of the invention;

FIG. 5 shows a cassette with a support held in it, and a last lens on the image side held so that it can be displaced.

FIG. 1 shows a meridian section through a microlithographic projection exposure apparatus, denoted overall by 10, in a highly simplified schematic representation. The projection exposure apparatus 10 has an illumination device 12 for generating projection light 13, which comprises inter alia a light source 14, illumination optics indicated by 16 and a diaphragm 18. In the exemplary embodiment represented, the projection light has a wavelength of 157 nm.

The projection exposure apparatus 10 furthermore has a projection objective 20 which contains a multiplicity of lenses, only some of which (denoted by L1 to L5) are represented by way of example in FIG. 1 for the sake of clarity. Owing to the short wavelength of the projection light 13, the lenses L1 to L5 are made of calcium fluoride crystals which are still sufficiently transparent even at these wavelengths. The projection objective 20 is used to project a reduced image of a reticle 24, arranged in an object plane 22 of the projection objective 20, onto a photosensitive surface 26 which is arranged in an image plane 28 of the projection objective 20 and is applied on a support 30.

The support 30 is fastened on the bottom of an open-topped container 32 in the shape of a trough, which can be displaced (in a way which is not represented in detail) parallel to the image plane 28 with the aid of a displacement device. The container 32 is filled sufficiently with an immersion liquid 34 so that, during operation of the projection exposure apparatus 10, the projection objective 20 is immersed with its last lens L5 on the image side in the immersion liquid 34. This lens L5 is a comparatively thick lens having a high aperture in the exemplary embodiment represented, although the term “lens” is in this context also intended to include a plane-parallel plate.

Via a feed line 36 and a discharge line 38, the container 32 is connected to a treatment unit 40 which (in a manner known per se and therefore not represented in detail) contains a circulating pump, a filter for cleaning immersion liquid 34 and a temperature regulating device. The treatment unit 40, the feed line 36, the discharge line 38 and the container 32 together form an immersion device denoted by 42, in which the immersion liquid 34 is circulated while being cleaned and kept at a constant temperature. The immersion device 32 is used in a manner known per se to increase the resolving power of the projection objective 20.

The treatment unit 40 furthermore contains a degasser indicated by 44, the structure of which will be explained in more detail below with reference to FIG. 3. Gaseous constituents, which could enter the gas phase in the container 32 and thereby lead to the formation of bubbles, are drawn from the circulating immersion liquid 34 by the degasser 44.

FIG. 2 shows another exemplary embodiment of an immersion device in an enlarged detail of the image-side end of the projection objective, parts corresponding to one another in FIGS. 1 and 2 being provided with the same reference numerals. It can be seen particularly clearly in this enlarged representation that—as in the exemplary embodiment shown in FIG. 1—the last lens L5 on the image side is held in a frame so that the plane image-side delimiting surface of the lens L5 merges into the frame 46 without forming projections or gaps. This reduces the likelihood that turbulence may form in this transition region, and consequently that bubbles 48 may be created.

The volume lying in the beam path of the projection objective 20 between the lens L5 and the photosensitive surface 26 is filled with immersion liquid 34, and will therefore be referred to below as an immersion space 50. The immersion space 50 is sealed laterally by an open-topped ring 52, and towards the photosensitive surface 26 by a sealing element 54. The sealing element 54 may be obviated if the pressure of the surrounding gas is high enough to prevent the immersion liquid 34 from emerging. The ring 52 contains a first bore 56, which is connected to the feed line 36 and whose end opening into the immersion space 50 forms a filling gland 58. The ring 52 furthermore contains a second bore 60, which is connected to the discharge line 38 and whose end opening into the immersion space forms a suction gland 62. The feed line 36 and the discharge line 38 are connected to a circulating pump 64, which can circulate the immersion liquid 34 in a closed circuit.

Upstream of the circulating pump 64 in the feed line 36, there is a degasser 44 which sets up a large negative pressure over a thin liquid film, and thereby draws gases dissolved in the immersion liquid 34 therefrom and greatly undersaturates it. Owing to this undersaturation, gases still dissolved in the immersion liquid 34 remain for the very dominant part in solution even when pressure or temperature variations take place.

Particularly when filling the immersion space 50 or when moving the support 30 relative to the last lens L5 on the image side, the pressure and temperature variations may nevertheless be so great that bubbles 48 can be created. In order to break up bubbles 48 which have already been created, an ultrasound source 66 is additionally provided which can act on the ring 52, as indicated by a double arrow in FIG. 2. The bubbles 48 are therefore set in high-frequency motion and thereby deformed, so that the bubbles 48 break up rapidly.

FIG. 3 schematically shows the degasser 44 in a cross section. Immersion liquid 34 is pumped into an annular distributor line 70 by means of a pump 68 via the discharge line 60 in the direction indicated by arrows.

From the distributor line 70, the immersion liquid 34 flows out as a thin film 72 down a run-off surface 74, frustoconically designed in the exemplary embodiment represented, which is preferably arranged in an inclined fashion, and finally collects in an outflow line 76, which is connected to the feed line 36 via the pump 64. The space 78 remaining over the run-off surface 74 is in communication with a vacuum pump 82 via a suction line 80, and can thereby be evacuated. The effect of the negative pressure thus created in the space 78 is that gases dissolved in the immersion liquid 34 are drawn from it.

FIG. 4 shows a part of an immersion device according to another exemplary embodiment, in which the immersion space 50 is framed by side walls only laterally, i.e. parallel to the plane of the paper, but not transversely to a scanning direction indicated by an arrow 84. The scanning direction 84 is the direction in which the support 30 moves under the lens L5 during the scanning operation. This relative motion between the support 30 and the lens L5 creates a transport effect, by which immersion liquid 34 emerging from a filling gland 58′ opening into the immersion space 50 is delivered to a suction gland 62′, which likewise protrudes into the immersion space 50. This transport motion prevents immersion liquid 34 escaping from the immersion space 50 counter to the scanning direction 84.

The transport effect can additionally be amplified if the distance indicated by d in FIG. 4, between the lens L5 and the photosensitive surface 26, decreases continuously in the scanning direction. The immersion space 50 can then have a wedge-shaped configuration which amplifies the transport effect and leads to particularly uniform filling of the immersion space 50 with immersion liquid 34. In order to produce such a wedge-shaped immersion space 50, for example, the support 30 with the photosensitive surface 26 applied on it may be slightly tilted. In order to achieve a correspondingly tilted image plane, the projection objective 20 may for example contain a wedge-shaped correcting element.

The frame 46′ of the lens L5 also includes a suction gland 86, the purpose of which is to immediately extract gas bubbles created in the exit region of the filling gland 58′, before they can reach the image-side delimiting surface of the lens L5 and cause imaging errors there.

FIG. 5 shows a further way in which it is possible to prevent the creation of bubbles in the immersion liquid 34. In this exemplary embodiment, the support 30 with the photosensitive surface 26 applied on it is held entirely in a cassette 90 closed all around, the entire remaining volume of which is filled with the immersion liquid 34. A last lens L5′ on the image side is fitted into the object-side wall, designed as a bellows 92, so that the lens L5′ can be displaced in the scanning direction indicated by an arrow 84′, but without the volume inside the cassette 90 thereby changing. This ensures that the immersion liquid 34 in the cassette 90 cannot enter in contact with a gas at any time.

A separate apparatus is preferably provided in order to introduce the support 30 with the photosensitive surface 26 into the cassette 90, and fill the remaining volume with the immersion liquid 34. This apparatus may comprise a vacuum pump, with which it is possible to ensure that the immersion liquid substantially freed of dissolved gases in the degasser can be introduced into the cassette 90, but without entering in contact with a gas. Even if the immersion liquid 34 in the cassette 90 is set in motion when the lens L5′ is displaced during the scanning process, in this way virtually no gases can enter the gas phase and thereby give rise to bubbles.

1-16. (canceled)

17. A projection exposure apparatus for microlithography, comprising:
an illumination system for generating projection light;
a projection objective comprising a plurality of optical elements for imaging a reticle onto a photosensitive surface; and,
an immersion device for introducing an immersion liquid into an immersion space formed between a last optical element on the image side of the projection objective and the photosensitive surface, wherein said immersion device comprises
a suction device having a suction nozzle opening into the immersion space and is configured to extract gas bubbles from the immersion liquid during the exposure operation.

18. The apparatus of claim 17, wherein the suction device is configured to extract the gas bubbles during operation of the apparatus.

19. The apparatus of claim 17, wherein a support for the photosensitive surface is configured to be displaceable in a scanning direction of the projection exposure apparatus, and wherein the immersion space is bound by side walls only parallel to the scanning direction, but not perpendicular thereto.

20. A projection exposure apparatus for microlithography, comprising:
an illumination system for generating projection light;
a projection objective comprising a plurality of optical elements for imaging a reticle onto a photosensitive surface;
an immersion space formed between a last optical element on the image side of the projection objective and the photosensitive surface, said immersion space being confined by at least one side wall; and,
an ultrasound source which induces oscillations in said at least one side wall for removing gas bubbles in an immersion liquid introduced into the immersion space.

21. A projection exposure apparatus for microlithography, comprising:
an illumination system for generating projection light;
a projection objective comprising a plurality of optical elements for imaging a reticle onto a photosensitive surface; and,
an immersion device for introducing an immersion liquid into an immersion space formed between a last optical element on the image side of the projection objective and the photosensitive surface, wherein said immersion device comprises circulation means for circulating the immersion liquid in the immersion space, said circulation means comprising
a circulating pump,
a filling nozzle opening into the immersion space,
a suction nozzle opening into the immersion space, and
a degasser for removing gas bubbles from the immersion liquid.

22. The apparatus of claim 21, wherein the degasser comprises:
a run-off surface that is obliquely arranged so that immersion liquid which is applied from above runs down the surface; and,
means for establishing a negative pressure above the run-off surface.

23. The apparatus according to claims 21, wherein the circulation means are integrated into the projection objective.

24. A projection exposure apparatus for microlithography, comprising:
an illumination system for generating projection light;
a projection objective comprising a plurality of optical elements for imaging a reticle onto a photosensitive surface; and,
an immersion device for introducing an immersion liquid into an immersion space formed between a last optical element on the image side of the projection objective and the photosensitive surface, wherein said immersion device is configured to introduce a flushing liquid different from the immersion liquid into the immersion space.

25. A method for introducing an immersion liquid into an immersion space which is formed between a last optical element on the image side of a projection objective of a projection exposure apparatus for microlithography and a photosensitive surface to be exposed, comprising the following steps:
wetting the photosensitive surface and the last optical element with the immersion liquid, wherein a support for the photosensitive surface is outside a beam path of the projection exposure apparatus;
bringing the support up to the last optical element in a movement parallel to an image plane of the projection objective, so that the immersion liquids on the last optical element and on the photosensitive surface touch; and,
introducing the support completely into the beam path in a movement parallel to the image plane until the support reaches the required position for exposure.

26. A projection exposure apparatus for microlithography, comprising:
an illumination system for generating projection light;
a projection objective, which has an image plane and comprises a plurality of optical elements for imaging a reticle onto a photosensitive surface arranged in the image plane; and,
a wedge-shaped immersion space formed between a last optical element on the image side of the projection objective and the photosensitive surface.
